(19) United States
(12) Patent Application Publication
(10) Pub. No.: US 2004/0134952 A1
(43) Pub. Date: Jul. 15, 2004

(54) All terrain vehicle and rack therefor

(76) Inventors: Jean-Phillipe Crepeau, Bromont (CA); Nicolas Laberge, Waterloo (CA); Jean Guillemette, Waterloo (CA); Vincent Morin, Sherbrooke (CA)

Correspondence Address: PILLSBURY WINTHROP, LLP, P.O. BOX 10500, MCLEAN, VA, 22102, US

(21) Appl. No.: 10/664,062

(22) Filed: Sep. 17, 2003

Related U.S. Application Data
(60) Provisional application No. 60/411,034, filed on Sep. 17, 2002.

(51) Int. Cl. B60R 7/00

(52) U.S. Cl. 224/400

(57) ABSTRACT

An all terrain vehicle is disclosed that includes a frame, a plurality of wheels that are suspended from the frame, and a support that is fixedly attached to the frame. A fender is fixedly attached to the support and a storage rack disposed above the frame and supported by at least one of the support and the fender. The storage rack includes at least two separate sections.

### CROSS-REFERENCE TO RELATED APPLICATIONS

This application claims the benefit of priority to U.S. Provisional Application No. 60/411,034, titled “ALL TERRAIN VEHICLE AND RACK THEREFOR,” filed Sep. 17, 2003, which is incorporated by reference herein in its entirety. This application is related to U.S. patent application Ser. No. ______ , titled “SERVICE CENTER FOR A RECREATIONAL VEHICLE,” filed Sep. 9, 2003, which claims the benefit of priority to U.S. Provisional Application No. 60/408,918, titled “SERVICE CENTER FOR A RECREATIONAL VEHICLE,” filed Sep. 9, 2002, both of which are incorporated by reference herein in their entireties.

### BACKGROUND OF THE INVENTION

1. Field of the Invention

This invention relates to an all terrain vehicle (ATV), and more particularly to an ATV having an improved storage rack.

2. Description of Related Art

Storage racks on all terrain vehicles (ATV's) have historically been fabricated from metal and then painted to the desired color. Metal storage racks are typically made from steel for sufficient strength and are costly to manufacture, largely because fabrication of the metal racks is labor intensive. Pieces of the rack must be formed, fastened together by welding, riveting, or other common fastening techniques, and then painted.

Metal storage racks can also be easily damaged, as the metal can be dented or bent when subjected to the harsh conditions an ATV may encounter. Any damage to the paint can make the rack susceptible to corrosion, thereby further weakening the rack structure.

A new generation of storage racks that are fabricated from plastic rather than metal have been introduced. Plastic racks overcome many of the drawbacks of metal racks. Plastic racks do not dent or permanently bend and do not have to be painted, as colors can be molded into the part.

U.S. Pat. No. 6,016,943 ('943 patent) describes a rack that is made from a fiber-filled plastic resin. The plastic resin includes fibers with lengths of at least ¼ inch. The rack described in the '943 patent is a one-piece rack and includes a plurality of reinforcing ribs. These reinforcing ribs have a complex design and are recessed below the top surface of the rack. The rack is manufactured by means of an injection molding machine. As a result of the necessary features of the rack, the design of the mold used in the injection molding machine is complex and fabrication of the mold is costly. Thus, there is a need for a more simple rack design.

In order for a rack to safely carry a load, the rack must be securely fastened to the ATV. However, due to the compact size of an ATV, there is not much room to provide extra storage and access to parts located under the exterior shell of the ATV. Once a rack is fixedly attached to the ATV, it is inconvenient to remove and as a result, design options are limited. Thus, there is a need for a rack that can allow easier access to parts located below the top surface of the ATV.

The market for ATV's is very dynamic. Designs and features of ATV's change somewhat frequently. For example, the color scheme of a particular ATV model may change each year. Therefore, it is important that the components of the ATV be flexible to allow for inexpensive changes. In the area of storage racks on ATV's, there is a specific need for a rugged, yet inexpensive and flexible rack system.

### SUMMARY OF THE INVENTION

It is, therefore, one aspect of the present invention to provide an all terrain vehicle with a storage rack that is rugged, yet inexpensive and flexible.

It is another aspect of the present invention to provide an all terrain vehicle with a storage rack the allows access to parts located beneath the storage rack.

It is, therefore, one aspect of the present invention to provide an all terrain vehicle with a frame, a plurality of wheels that are suspended from the frame, and a support that is fixedly attached to the frame. A fender is fixedly attached to the support and a storage rack is disposed above the frame and supported by at least one of the support and the fender. The storage rack includes at least two separate sections.

Another aspect of the present invention is to provide a storage rack for an all terrain vehicle that includes a first section and a second section. The first section and the second section include injection molded plastic that includes a polymer and glass fibers. The glass fibers each have a length of up to about ⅛ inch.

These and other aspects of embodiments of the invention will become apparent when taken in conjunction with the following detailed description and drawings.

### BRIEF DESCRIPTION OF THE DRAWINGS

Preferred embodiments of the invention will be described in conjunction with the following drawings, wherein:

FIG. 1 is a front perspective view illustrating an ATV having a storage rack of embodiments of the present invention;

FIG. 2 is a top perspective view of a left section of the storage rack;

FIG. 3 is a bottom view of the left section of the storage rack;

FIG. 4 is a perspective partial cross-sectional view illustrating one embodiment of the attachment between the front storage rack and the support of the ATV;

FIG. 5 is an enlarged cross-sectional detail of the attachment illustrated in FIG. 4; and

FIG. 6 is a top perspective view illustrating the center section of the storage rack.

### DETAILED DESCRIPTION OF THE INVENTION

Although the embodiments described below specifically describe a storage rack as mounted and used on an all terrain vehicle (ATV), it is understood that such a rack could be mounted to other vehicles, particularly off-road vehicles, including but not limited to snowmobiles.

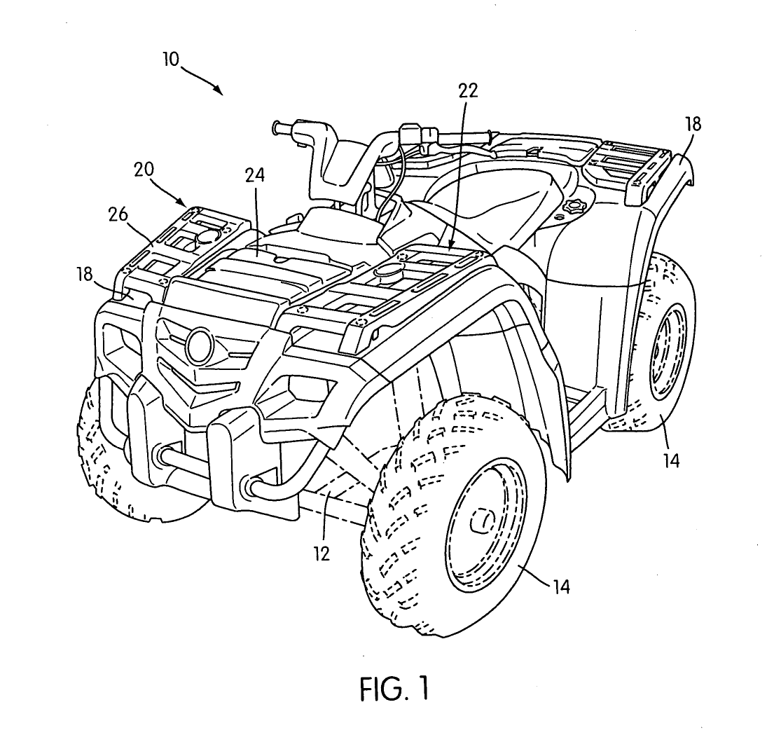

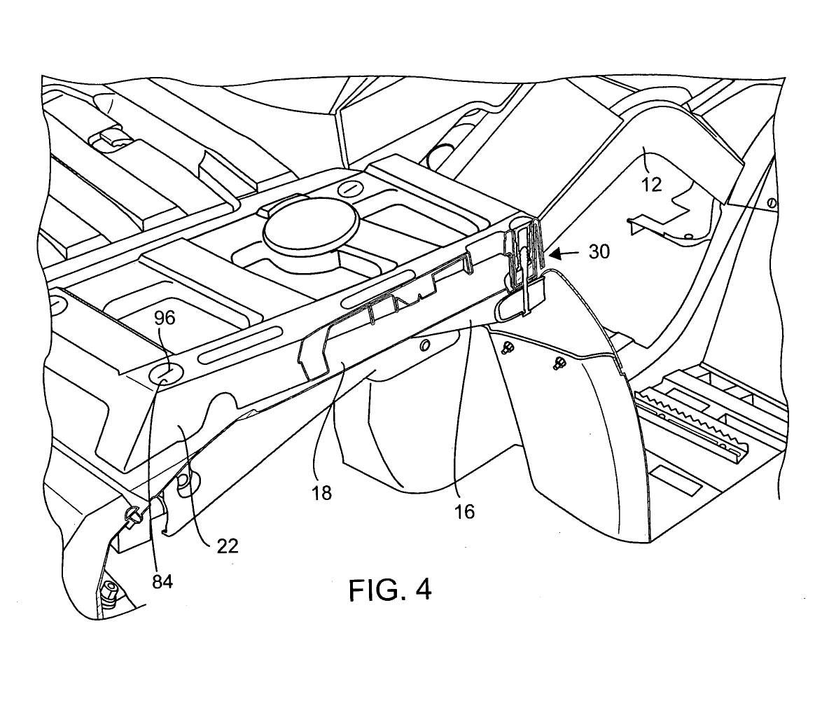

FIG. 1 illustrates an ATV 10 according to at least one embodiment of the invention. The ATV 10 includes a frame 12 from which a plurality of wheels 14 are suspended. A support 16 (shown in FIG. 4) is fixedly attached to the frame 12, and a fender 18 is fixedly attached to the support 16. A storage rack 20 is mounted adjacent to the fender 18.

The frame 12 is fabricated from metal, preferably from steel, by techniques well known in the art. The frame 12 is sized to support all of the components of the ATV 10, including but not limited to the wheels 14. Similarly, the wheels 14 are sized to support the ATV 10 and to handle rugged terrain.

The support 16 is fixedly attached to the frame 12 by common joining techniques. The support 16 can be welded to the frame 12, or attached with fasteners, such as rivets or bolts or the like. The support 16 is fabricated from metal, such as steel or aluminum. The support 16 includes pre-drilled holes specifically located such that additional parts can be attached to the support 16.

The fender 18 is fixedly attached to the support 16, preferably by fasteners, which allow the fender 18 to be easily removed, if needed. The fender 18 may be fabricated from sheet metal or may by formed from plastic. Standard stamping techniques can be used if sheet metal is utilized. Preferably, the fender 18 is formed from plastic. Standard plastic forming processes can be used, including but not limited to thermoforming, injection molding, and blow molding. Preferably, the fender 18 is injection molded.

The fender 18 comprises at least one piece. Preferably, the fender 18 comprises two pieces. A first fender 18 can be mounted to a front section of the support 16 and a second fender 18 can be mounted to a rear section of the support 16.

The fender 18 may be molded in many different shapes. For example, a storage compartment may be integrally molded into the fender 18. Also, recessed portions and/or raised portions may be integrally molded into the fender 18 to allow for easier mounting of additional parts. This flexibility can lead to ATV's 10 with improved aerodynamics and styling.

The storage rack 20 is mounted adjacent to the fender 18 and comprises at least two sections. Preferably, the design of the storage rack 20 complements the design of the fender 18 so that the storage rack 20 is indexed to the fender 18, making assembly much easier. The storage rack 20 can be made from any material, but is preferably formed from a plastic resin. Standard plastic forming processes can be used, including but not limited to thermoforming, injection molding, and blow molding. Preferably, the storage rack 20 is injection molded.

In the preferred embodiment, the storage rack includes a polymer and a filler. The filler is mixed with the polymer prior to molding. The filler may include standard polymer additives such as impact modifiers, powders or fibers. Preferably, the filler includes fibers. More preferably, the filler includes glass fibers. In the preferred embodiment, glass fibers with an initial length of about ⅜ inch or less are subjected to a churning process. After the churning process, the lengths of the fibers have been reduced to about ⅛ inch.

The fibers are then mixed with the polymer and injection molded into a storage rack 20. Polymers that can be used to make the storage rack 20 include but are not limited to polyesters, polycarbonates, and polyolefins. Preferably, the injection molded storage rack 20 includes polypropylene. Thus, in the preferred embodiment, the injection molded storage rack 20 includes polypropylene and glass fibers with lengths of up to about ⅛ inch.

The storage rack includes at least two sections. Preferably, the storage rack 20 includes a left section 22 and a right section 26, as shown in FIG. 1. In the preferred embodiment, the storage rack 20 further includes a center section 24. The center section 24 can be molded in a design that complements the left section 22 and the right section 26. This allows for the storage rack 20 to include more that one piece, yet act as one continuous piece.

Alternatively, the storage rack 20 may be integrally formed as part of the fender 18. In the preferred embodiment, the left section 22, the center section 24, and the right section 26 are three individual pieces, as illustrated in FIG. 1. Because the left section 22 and the right section 26 are substantially mirror opposites of one another, only the left section 22 will be described in greater detail. It is understood by one of ordinary skill in the art that the same description applies to the right section 26 as well.

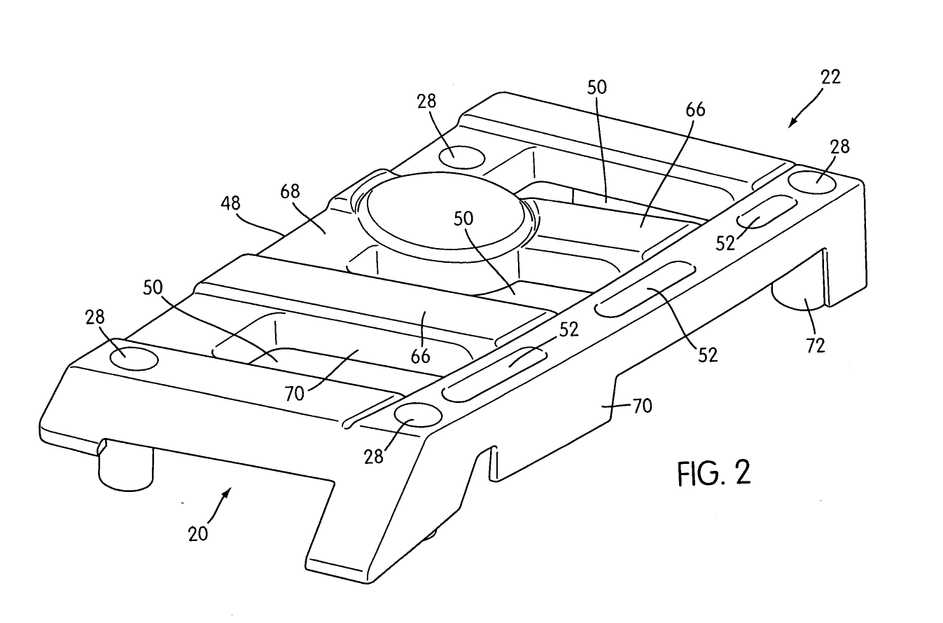

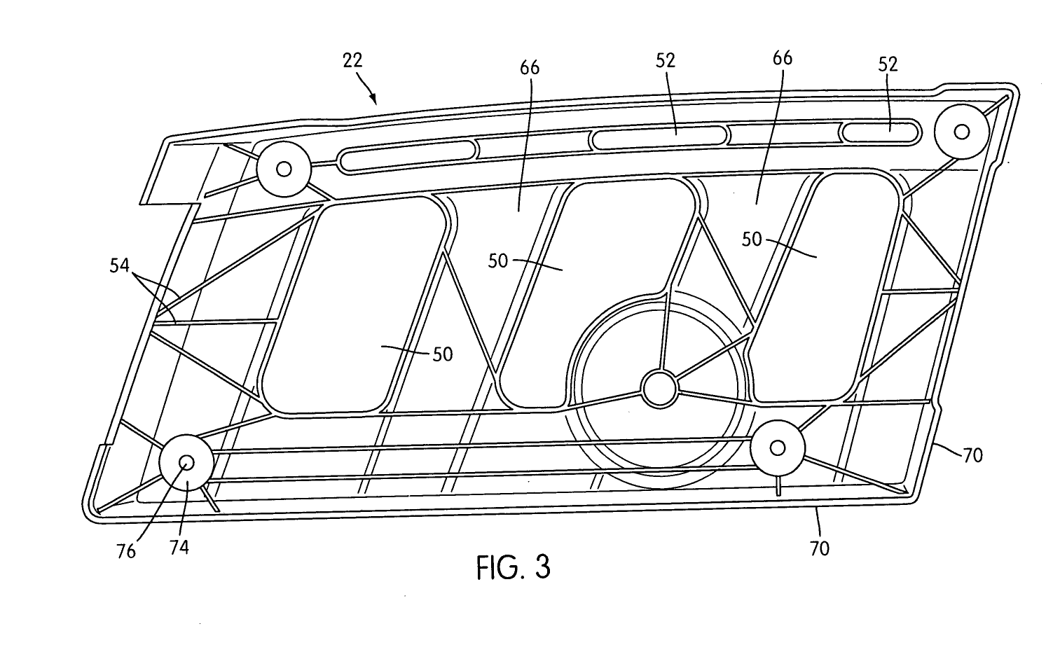

FIG. 2 illustrates a top perspective of the left section 22 of the storage rack 20. The left section 22 may be a solid piece. Preferably, the left section 22 includes openings, slots, and holes. FIG. 3 illustrates a bottom view of the left section 22 of the storage rack 20.

In the preferred embodiment, the left section 22 includes a solid portion 48, a plurality of openings 50, a plurality of slots 52, and a plurality of positioning holes 28. The solid portion 48 comprises a top 68 and a plurality of structural ribs 70. The top 68 of the solid portion 48 is generally horizontal. The structural ribs 70 are generally vertical and extend generally downward from the top 68 of the solid portion 48.

The solid portion 48 further comprises cross-members 66. The cross-members 66 are located between the openings 50. The cross-members 66 may be slightly raised as compared to the rest of the solid portion 48 to help carry items on the storage rack 20.

The slots 52 can be utilized to attach bungee cords and the like to the solid portion 48 to help secure items to the storage rack 20. The slots 52 are surrounded by structural ribs 70 for added strength.

In the preferred embodiment, the plurality of positioning holes 28 include four positioning holes 28. Preferably, each positioning hole 28 is located relatively close to a corner of the storage rack 20, as illustrated in FIGS. 2 and 3.

At each positioning hole 28, a structural rib 70 extends from the top 68 of the solid portion 48 generally downward to form a hollow cylinder 72 with an inside diameter equal to the inside diameter of the positioning hole 28. The hollow cylinder 72 further includes a bottom 74. The bottom 74 includes a mounting hole 76. The mounting hole 76 has a diameter less than the diameter of the positioning hole 28.

The solid portion 48 further includes a plurality of strengthening ribs 54, as illustrated in FIG. 3. The strengthening ribs 54 are molded as an integral part of the solid portion 48. The strengthening ribs 54 extend generally downward from the top 58 of the solid portion 48. From the top and side perspectives, the strengthening ribs 54 are hidden from view. Thus, the strengthening ribs 54 are hidden from view when the storage rack 20 is mounted to the ATV 10.

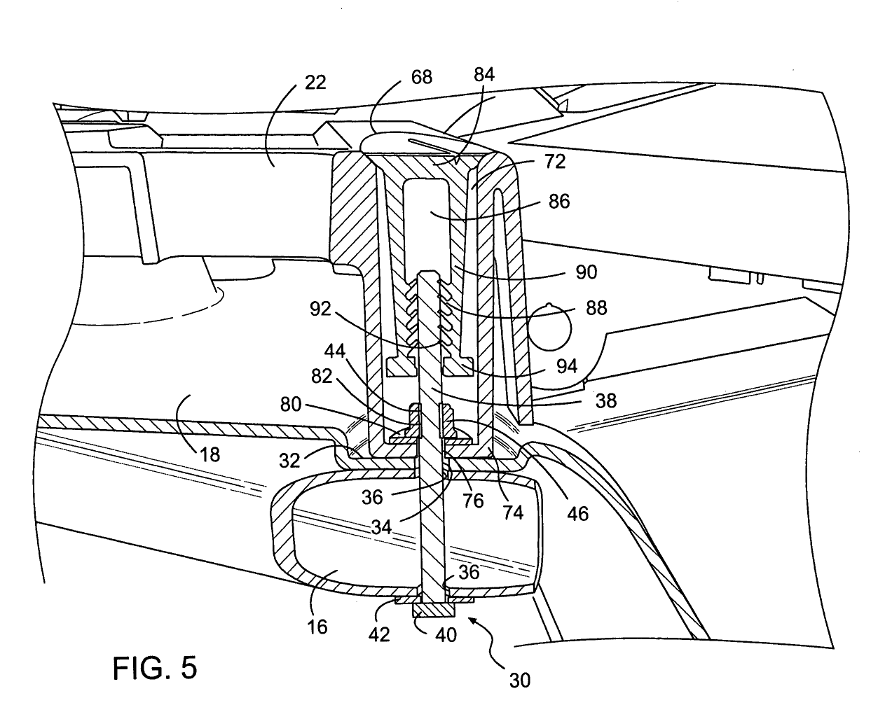

FIG. 4 is a partial cross-sectional view of the left front storage rack portion 22 positioned above the fender 18. As illustrated, the left section 22 of the storage rack 20 is attached to the fender 18 and the support 16 of the ATV 10 via a fastener 30. FIG. 5 illustrates the fastener 30 in greater detail.

As shown in FIG. 5, the fastener 30 is made up of several separate components that cooperate to securely fasten the left section 22 of the storage rack 20 to the fender 18 and support 16 of the ATV 10. Preferably, the bottom 74 of the hollow cylinder 72 registers with an indentation 32 in the fender 18. The mounting hole 76 registers with a hole 34 in the fender 18 and a hole 36 in the support 16.

To attach the left section 22 of the storage rack 20 to the support 16, a pin 38 is inserted through the hole 36 in the support so that a head 40 of the pin 38 sandwiches a washer 42 between itself and the support 16. The shaft of the pin 38 extends through the support 16, passes through the holes 34, 76, and is positioned within the hollow cylinder 72. The shaft of the pin 38 includes a number of grooves 44 therein. A grommet 46 sandwiches a washer 80 between itself and the bottom 74 of the hollow cylinder 72. The grommet 46 includes a plurality of protrusions 82 on the inner surface of the bore therethrough. The protrusions 82 engage the grooves 44 on the shaft of the pin 38 to retain the grommet 46 in a fixed relationship to the pin 38. In this manner the left section 22 of the storage rack 20 is held securely to the support 16.

To cover the hollow cylinder 72, a cap 84 is provided. The cap 84 has a hollow interior 86. At a bottom portion of the hollow interior 86, the cap 84 is provided with a number of protrusions 88 that extend inwardly from a wall 90. The protrusions 88 are designed to mate with grooves 92 on the tip end of the pin 38 so that the cap 84 is secured to the pin 38, thereby closing the hollow cylinder 72. To provide greater rigidity to the wall 90, an annular end 94 is provided at the bottom end of the cap 84.

The protrusions 82 on the grommet 46 are illustrated as vertical protrusions that engage vertically-disposed grooves 44 on the pin 38. As would be appreciated by those skilled in the art, however, the protrusions 82 and grooves 44 may be designed to threadedly engage one another, thereby securely fastening the left section 22 of the storage rack 20 to the support 16.

Similarly, the protrusions 88 on the wall 90 of the cap 84 may be designed to threadedly engage the grooves 92 on the pin 38. As illustrated in FIG. 4, the cap 84 may be provided with a slot 96 into which a screwdriver may be inserted to tighten the cap 84 in the hollow cylinder 72.

The individual elements of the fastener 30 preferably are constructed from a plastic material to provide the greatest amount of flexibility while retaining a sufficient amount of rigidity to create a secure connection between the left section 22 of the storage rack 20, the fender 18, and the support 16. However, as would be appreciated by those skilled in the art, any other suitable material may be used, including steel, aluminum, or an equivalent material.

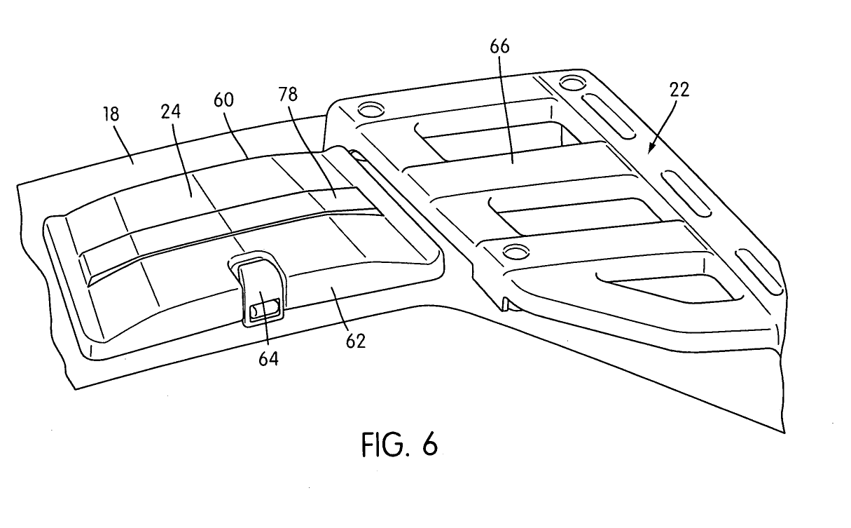

FIG. 6 illustrates the preferred embodiment of the center section 24 as it is mounted to the fender 18. A first side 60 of the center section 24 of the storage rack 20 is hingedly attached to the fender 18 along a hinge axis. A second side 62 of the center section 24, located opposite the first side 60, is attached to the fender 18 with a latch 64 or some other similar type device. This allows for the center section 24 to be securely fastened to the fender 18 while the ATV 10 is in motion. When the ATV 10 is at rest, the center section 24 can be unlatched and rotated about the hinged axis to an open position so that the items located under the center section 24 can be accessed.

Although the center section 24 can include the same features of the left section 22 and the right section 26, in the preferred embodiment, the center section 24 is substantially solid. That is, there are no openings, holes, or slots in the center section 24.

In the preferred embodiment, the center section 24 includes at least one raised portion 78 that is slightly raised above the rest of the center section 24. The center section 24 can be designed to match the left section 22 and, hence, the right section 26, such that the raised portion 78 of the center section 24 is in-line with the cross-member 66 of the left section 22. This allows the sections of the storage rack 20 to better perform as one continuous unit.

One of ordinary skill in the art would recognize that the storage rack heretofore described can be mounted to a front fender or a rear fender, or both.

While preferred embodiments of the invention have been shown and described, it is evident that variations and modifications are possible that are within the spirit and scope of the preferred embodiments described herein.

What is claimed is:

1. An all terrain vehicle comprising:
a frame;
a plurality of wheels suspended from the frame;
a support fixedly attached to the frame;
a fender fixedly attached to the support; and
a storage rack disposed above the frame and supported by at least one of the support and the fender, wherein the storage rack comprises at least two separate sections.

2. The all terrain vehicle of claim 1, wherein the storage rack is mounted adjacent to the fender.

3. The all terrain vehicle of claim 1, wherein the storage rack comprises injection molded plastic.

4. The all terrain vehicle of claim 3, wherein the injection molded plastic comprises a polymer and a filler.

5. The all terrain vehicle of claim 4, wherein the filler comprises fibers.

6. The all terrain vehicle of claim 5, wherein the fibers comprise glass fibers with lengths of up to about ⅛ inch.

7. The all terrain vehicle of claim 1, wherein the storage rack comprises a left section and a right section.

8. The all terrain vehicle of claim 7, wherein the storage rack further comprises a center section.

9. The all terrain vehicle of claim 8, wherein the center section comprises a cover with a first side and a second side.

10. The all terrain vehicle of claim 9, wherein the first side of the cover is hingedly attached to the fender.

11. The all terrain vehicle of claim 9, wherein the second side of the cover comprises a latch.

12. The all terrain vehicle of claim 9, wherein the center section is substantially solid.

13. The all terrain vehicle of claim 1, wherein the storage rack comprises a solid portion and a plurality of openings.

14. The all terrain vehicle of claim 13, wherein the storage rack further comprises a plurality of slots and a plurality of positioning holes.

15. The all terrain vehicle of claim 14, wherein at least one of the plurality of positioning holes is in register with at least one hole defined by the support.

16. The all terrain vehicle of claim 13, wherein the solid portion of the storage rack further comprises a top and a plurality of structural ribs.

17. The all terrain vehicle of claim 16, wherein the top is substantially horizontal and the plurality of structural ribs extend general downward from the top.

18. The all terrain vehicle of claim 13, wherein the solid portion of the storage rack further comprises a plurality of strengthening ribs.

19. The all terrain vehicle of claim 18, wherein the plurality of strengthening ribs extend generally downward from the top.

20. The all terrain vehicle of claim 18, wherein the plurality of strengthening ribs are on a bottom of the storage rack.

21. The all terrain vehicle of claim 1, wherein the storage rack is attached to the support by at least one fastener.

22. The all terrain vehicle of claim 21, wherein the fastener comprises:
a pin extending through holes in one of either the fender or the support and the storage rack, the pin having a head that retains the pin when disposed through one of either the support or the fender; and
a grommet disposed adjacent the storage rack, the grommet being releasably attached to the pin to retain the fender and the storage rack against the support.

23. A storage rack for an all terrain vehicle comprising:
a first section; and
a second section,
wherein the first section and the second section comprise injection molded plastic comprising a polymer and glass fibers, the glass fibers each having a length of up to about ⅛ inch.

24. The storage rack of claim 23, further comprising a center section disposed between the first section and the second section.

25. The storage rack of claim 24, wherein the center section comprises a cover with a first side and a second side.

26. The storage rack of claim 25, wherein the first side of the cover is hingedly attached to the fender.

27. The storage rack of claim 26, wherein the second side of the cover comprises a latch.

28. The storage rack of claim 23, wherein the storage rack comprises a solid portion and a plurality of openings.

29. The storage rack of claim 28, wherein the storage rack further comprises a plurality of slots and a plurality of holes.

30. The storage rack of claim 28, wherein the solid portion of the storage rack further comprises a top and a plurality of structural ribs.

31. The storage rack of claim 30, wherein the top is substantially horizontal and the plurality of structural ribs extend generally downward from the top.

32. The storage rack of claim 31, wherein the solid portion of the storage rack further comprises a plurality of strengthening ribs.

33. The storage rack of claim 32, wherein the plurality of strengthening ribs extend generally downward from the top.

34. The storage rack of claim 23, wherein the storage rack is integrally formed with a fender.
